(19) United States
(12) Patent Application Publication
(10) Pub. No.: US 2025/0284068 A1
(43) Pub. Date: Sep. 11, 2025

(54) PORT DUST PLUG AND COMMUNICATION DEVICE

(71) Applicant: Ruijie Networks Co., Ltd., Fuzhou (CN)

(72) Inventors: Xusheng CHENG, Fuzhou (CN); Zhangfeng Huang, Fuzhou (CN); Wei Hu, Fuzhou (CN); Xin Wu, Fuzhou (CN)

(21) Appl. No.: 19/218,865

(22) Filed: May 27, 2025

Related U.S. Application Data
(63) Continuation of application No. PCT/CN2024/122683, filed on Sep. 30, 2024.

(30) Foreign Application Priority Data
Nov. 16, 2023 (CN) 202323101522.4

(51) Int. Cl. G02B 6/38; G02B 6/42

(52) U.S. Cl. CPC G02B 6/3849; G02B 6/4292

(57) ABSTRACT

This application discloses a port dust plug and a communication device, applied to an optical module slot of an optical cage, where the port dust plug includes: a main body portion, where the main body portion is provided with an insertion end at an end of the port dust plug in an insertion and removal direction, and the insertion end is provided with a connector accommodation recess having an opening direction facing away from the main body portion.

### CROSS-REFERENCE TO RELATED APPLICATIONS

This application is a continuation of International Application No. PCT/CN2024/122683, filed on Sep. 30, 2024, which claims priority to Chinese Patent Application No. 202323101522.4, filed with the China National Intellectual Property Administration on Nov. 16, 2023 and entitled “PORT DUST PLUG AND COMMUNICATION DEVICE”, which are incorporated herein by reference in their entireties.

### TECHNICAL FIELD

This application relates to the field of communication technology, and in particular, to a port dust plug and a communication device.

### BACKGROUND

An optical module plays a key role in an Ethernet switch. The optical module provides a high-speed and reliable fiber interface for the Ethernet switch, enabling a critical connection for fiber transmission. The flexibility, upgradability, and capability of supporting multiple fiber types of the optical module allow the Ethernet switch to adapt to different network requirements and provide stable and efficient data transmission.

### SUMMARY

Exemplary embodiments of this application provide a port dust plug and a communication device.

According to a first aspect, a port dust plug is provided, applied to an optical module slot of an optical cage, including:

a main body portion, where the main body portion is provided with an insertion end at an end of the port dust plug in an insertion and removal direction, and the insertion end is provided with a connector accommodation recess having an opening direction facing away from the main body portion.

When the port dust plug is inserted into the slot of the optical cage, a connector is located within the connector accommodation recess, and the optical cage, the connector, and the port dust plug enclose a sealed space, with the connector isolated within the sealed space, preventing exposure of the connector of the port to air, thereby providing a dustproof effect for the connector, allowing the connector to be not prone to interference from external dust, and achieving a favorable dustproof effect for the connector.

In an embodiment, the connector accommodation recess is a groove, and the groove extends in a width direction of the main body portion.

In an embodiment, an end face of the insertion end is provided with two protruding ribs, and the two protruding ribs are both perpendicular to the insertion and removal direction to enclose the groove.

In an embodiment, an end face of the insertion end is provided with two protruding ribs, and the two protruding ribs and a bottom of the connector accommodation recess form the groove.

In an embodiment, the two protruding ribs are integrally formed with the main body portion.

In an embodiment, two ends of the groove in an extension direction of the groove are through.

In an embodiment, the two protruding ribs are parallel to each other.

In an embodiment, the two protruding ribs intersect each other.

In an embodiment, each of the two protruding ribs has a surface facing the other, the surface is provided with a flared slope, and a distance between the flared slopes of the two protruding ribs gradually increases in a direction facing away from the main body portion.

In an embodiment, the main body portion has a ventilation channel, and the main body portion further includes:

one or more first ventilation openings provided at an end of the main body portion away from the insertion end, where the first ventilation openings are in communication with the ventilation channel.

In an embodiment, the main body portion further includes: at least one third ventilation opening provided at the insertion end of the main body portion, where the third ventilation opening is in communication with the ventilation channel.

In an embodiment, the third ventilation opening is not in communication with the connector accommodation recess.

In an embodiment, an arrangement direction of the third ventilation opening and the connector accommodation recess is a height direction of the port dust plug.

In an embodiment, the main body portion has at least two longitudinal convex ribs arranged at intervals and extending along the insertion and removal direction; and the at least two longitudinal convex ribs form a strip-shaped groove, and the ventilation channel is formed in the strip-shaped groove.

In an embodiment, the strip-shaped groove is internally provided with at least two transverse convex ribs arranged at intervals along the insertion and removal direction, and the at least two transverse convex ribs are connected to the at least two longitudinal convex ribs.

In an embodiment, the main body portion further includes: a second ventilation opening, where the second ventilation opening is arranged in the strip-shaped groove, and an orientation of the second ventilation opening is perpendicular to the insertion and removal direction and perpendicular to a width direction of the port dust plug.

In an embodiment, upper surfaces of the at least two transverse convex ribs are lower than upper surfaces of the at least two longitudinal convex ribs.

In an embodiment, a material of the main body portion is an elastic material.

In an embodiment, a bottom of the connector accommodation recess is an arc surface or a flat surface.

In an embodiment, the main body portion is provided with a handheld end at an end away from the insertion end, the main body portion has a ventilation channel, the ventilation channel forms a first ventilation opening at the handheld end, the ventilation channel further has a second ventilation opening, and an orientation of the second ventilation opening is perpendicular to the insertion and removal direction.

In an embodiment, the main body portion has a plurality of longitudinal convex ribs arranged at intervals and extending along the insertion and removal direction; every two adjacent longitudinal convex ribs enclose one strip-shaped groove, each strip-shaped groove forms one ventilation channel, each first ventilation opening is in communication with one corresponding strip-shaped groove, and an opening of each strip-shaped groove, having an orientation perpendicular to the insertion and removal direction, forms the second ventilation opening.

In an embodiment, every two adjacent longitudinal convex ribs are connected to each other through a plurality of transverse convex ribs arranged at intervals along the insertion and removal direction.

In an embodiment, when the connector accommodation recess is a groove formed on the end face of the insertion end, an arrangement direction of the second ventilation opening and the connector accommodation recess is perpendicular to an extension direction of the groove.

In an embodiment, the handheld end is provided with a handle, and the handle is provided with a skidproof stripe.

In an embodiment, a material of the main body portion is rubber.

According to a second aspect, a communication device is provided, and the communication device includes a connector, an optical cage, and the port dust plug according to any one of the above technical solutions, where the optical cage has an optical module slot, the port dust plug is inserted into the optical module slot, a sidewall of the optical cage covers an opening of the connector accommodation recess to enclose a sealed space, and the connector is located within the sealed space.

As compared with the conventional technology, the advantages of the communication device are the same as those of the port dust plug and are not repeated herein.

### BRIEF DESCRIPTION OF DRAWINGS

To describe the technical solutions of the embodiments of this application more clearly, the following briefly describes the accompanying drawings required for describing the embodiments of this application. Apparently, the accompanying drawings in the following descriptions show merely some embodiments of this application, and persons of ordinary skill in the art may still derive other accompanying drawings from these accompanying drawings without creative efforts.

FIG. 1 is a three-dimensional view of a port dust plug from one perspective according to an embodiment of this application;

FIG. 2 is a three-dimensional view of a port dust plug from another perspective according to an embodiment of this application.

### DESCRIPTION OF EMBODIMENTS

In this specification, the term “include” and any variations thereof are intended to cover non-exclusive protection. For example, a process, method, system, product, or device that includes a series of steps or units is not limited to the listed steps or units, but optionally further includes unlisted steps or units, or optionally further includes other steps or units inherent to the process, method, system, product, or device. The term “a plurality of” in this application may refer to at least two, such as two, three, or more, which is not limited by the embodiments of this application.

In the description of this application, “a plurality of” is understood as “at least two.” The term “and/or” describes an association relationship of associated objects, indicating that three relationships may exist. For example, A and/or B may indicate the following three cases: presence of only A; presence of both A and B; and presence of only B.

Unless otherwise defined by the context, the term “connect” in this specification may indicate that one element is directly connected to another element, or that one element is connected to another element through an intermediate element.

Unless otherwise defined by the context, the terms “first” and “second” in this specification are only used to distinguish identical or similar elements, and should not be understood as indicating or implying the importance of different elements, nor as indicating or implying a sequence.

A conventional network switch generally has an open port, and a connector of the port does not have a dustproof structure and is directly exposed to air. Air often contains dust, and dust easily enters an optical port connector, causing poor contact of the optical port connector with an optical module, affecting user experience, and even affecting heat dissipation, thus leading to overheating of the optical module and shortening the service life of components.

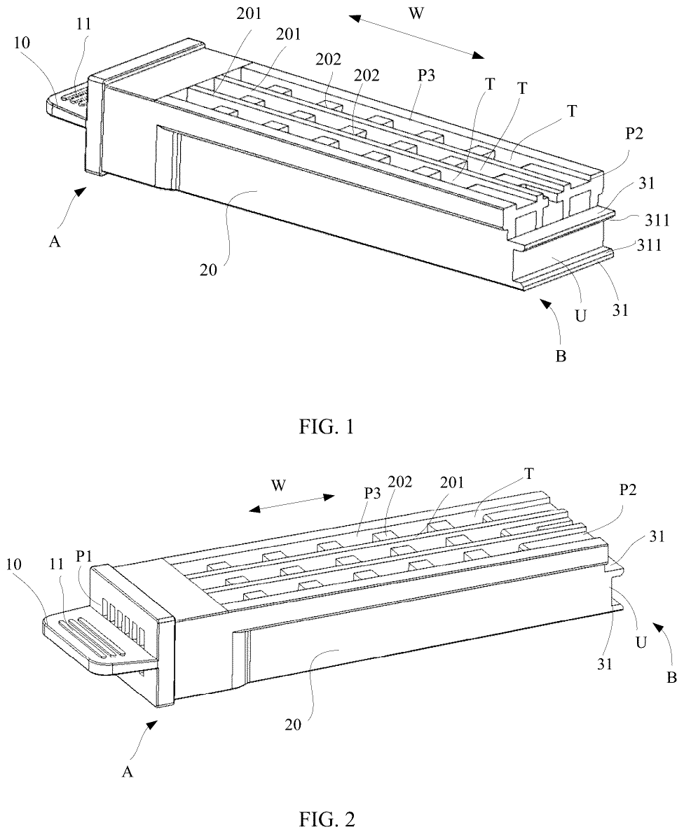

The following clearly and thoroughly describes the technical solutions in the embodiments of this application with reference to the accompanying drawings in the embodiments of this application. Apparently, the described embodiments are only some rather than all embodiments of this application. All other embodiments obtained by persons of ordinary skill in the art based on the embodiments of this application without creative efforts shall fall within the protection scope of this application. Referring to FIG. 1 and FIG. 2, exemplary embodiments of this application provide a port dust plug. The port dust plug is applied to an optical module slot of an optical cage. The port dust plug includes: a main body portion 20 made of an elastic material, where an insertion end B is formed at an end of the main body portion 20 in an insertion and removal direction W, and the insertion end B is formed with a connector accommodation recess U having an opening direction facing away from the main body portion 20.

When the port dust plug is inserted into the slot of the optical cage, a connector is located within the connector accommodation recess U, and the optical cage, the connector, and the port dust plug enclose a sealed space, with the connector isolated within the sealed space, allowing the connector to be not prone to intrusion of external dust, and achieving a favorable dustproof effect for the connector.

In a specific embodiment, the connector accommodation recess U may be a groove formed on an end face of the insertion end B, and an extension direction of the groove is perpendicular to the insertion and removal direction W. Two ends of the groove in the extension direction may be directly sealed by a sidewall of the optical module slot of the optical cage. Therefore, two ends of the groove in a length direction (as shown in FIG. 1, a width direction of the main body portion 20 perpendicular to the insertion and removal direction W) are directly through. On one hand, this can reduce materials of the main body portion 20. On the other hand, this can also provide more tolerance margin for the connector in the width direction, so that the connector is less likely to collide with a sidewall of the groove (in this embodiment, the sidewall is the sidewall of the optical module slot) in the width direction, that is, the connector is more easily placed within the groove U.

The groove forming the connector accommodation recess U may be formed in various methods, that is, a portion of the end face of the insertion end B can be directly removed through a known process (for example, etching) to form the groove. In other embodiments, the following method may also be adopted: the end face of the insertion end B is provided with two parallel protruding ribs 31, and the two protruding ribs 31 are both perpendicular to the insertion and removal direction W and extend in the width direction of the main body portion 20 to enclose the groove.

The protruding ribs 31 may be made of the same material as the main body portion 20.

The protruding ribs 31 may be integrally injection-molded with the main body portion 20, making the groove structure more secure and stable. The structures of the protruding ribs 31 are more prone to deformation, and when abutting against the sidewall of the optical module slot, the protruding ribs 31 are more prone to elastic deformation, resulting in a smaller gap between the protruding ribs 31 and the sidewall of the optical module slot, and making it more difficult for dust to enter the connector accommodation recess U.

In this embodiment, the two protruding ribs 31 being parallel is merely an example; alternatively, the two protruding ribs 31 may intersect, as long as the connector can be accommodated in the connector accommodation recess U.

Additionally, a surface of each protruding rib 31 facing the other protruding rib 31 may further be provided with a flared slope 311. A distance between the flared slopes 311 of the two protruding ribs 31 gradually increases in a direction facing away from the main body portion 20 to provide guidance for entry of the connector.

In a specific embodiment, a bottom of the connector accommodation recess U may be an arc surface or a flat surface. When the bottom of the accommodation recess U is an arc surface, the problem of stress concentration caused by a sharp included angle due to a squeezing force applied by the sidewall of the optical module slot to the connector accommodation recess U can be eliminated, thereby prolonging the service life of the port dust plug.

When the bottom of the accommodation recess U is a flat surface, a depth of the accommodation recess U is relatively shallower, requiring fewer materials to be removed, and providing good structural stability. Additionally, the bottom of the connector accommodation recess U may be a surface of another shape, such as an irregular curved surface.

In a specific embodiment, a handheld end A is formed at an end of the main body portion 20 away from the insertion end B, the main body portion 20 has a ventilation channel T, the ventilation channel T forms a first ventilation opening P1 at the handheld end A, the ventilation channel T further has a second ventilation opening P3, and an orientation of the second ventilation opening P3 is perpendicular to the insertion and removal direction W. The ventilation channel T provides a flow guiding function, the external air flows into the ventilation channel T from the first ventilation opening P1, and the air flowing into the ventilation channel T from the first ventilation opening P1 can flow out through the second ventilation opening P3 along a direction perpendicular to the insertion and removal direction W, and then flows out through an outlet in a top wall of the optical module slot to enter an internal space of a communication device for air exchange.

In an embodiment, the ventilation channel T may further form a third ventilation opening P2 at the insertion end B, and the air flowing into the ventilation channel T from the first ventilation opening P1 flows out from the third ventilation opening P2, enabling ventilation between the external environment and components in the internal space of the communication device, and further improving the heat exchange effect.

The ventilation channel T may take various specific forms. An interior of the main body portion 20 can be directly hollowed out to form the ventilation channel T.

In a specific embodiment, the main body portion 20 has a plurality of longitudinal convex ribs 201 arranged at intervals and extending along the insertion and removal direction W, and the longitudinal convex ribs 201 can provide reinforcement in the insertion and removal direction W; every two adjacent longitudinal convex ribs 201 enclose one strip-shaped groove, each strip-shaped groove forms one ventilation channel T, each first ventilation opening P1 is communication with one corresponding strip-shaped groove, an opening of each strip-shaped groove at the insertion end B forms one third ventilation opening P2, and an opening of each strip-shaped groove, having an orientation perpendicular to the insertion and removal direction W, forms a second ventilation opening P3. The strip-shaped groove is not limited to an open groove type, and may alternatively be a closed groove type such as a rhombic groove, or various other groove types.

In a specific embodiment, every two adjacent longitudinal convex ribs 201 are connected to each other through a plurality of transverse convex ribs 202 arranged at intervals along the insertion and removal direction W, and the transverse convex ribs 202 can further reinforce the adjacent longitudinal convex ribs 201 in a width direction perpendicular to the insertion and removal direction W.

A height of the transverse convex rib 202 may be lower than a height of the longitudinal convex rib 201 to ensure that airflow along the insertion and removal direction W is not obstructed by the transverse convex rib 202, thereby guaranteeing both the structural strength and the flow guiding function. Alternatively, the transverse convex rib 202 may be flush with the longitudinal convex rib 201.

In a specific embodiment, when the connector accommodation recess U is a groove formed on the end face of the insertion end B, an arrangement direction of the third ventilation opening P2 and the connector accommodation recess U is perpendicular to an extension direction of the groove. The third ventilation opening P2 is not in communication with the connector accommodation recess U. For example, the third ventilation opening P2 is not in communication with two ends of the connector accommodation recess U in a length direction of the groove, thereby preventing the ventilation channel T from being in communication with a sealed space enclosed by the connector accommodation recess U, and avoiding contamination of the connector in the sealed space by dust.

In a specific embodiment, the handheld end A is provided with a handle 10, and the handle 10 is provided with a skidproof stripe 11, helping an operator to grip the handle 10 for insertion and removal operations, and providing an anti-slip effect during insertion and removal.

In a specific embodiment, a material of the main body portion 20 may be rubber. The rubber has good elasticity and friction coefficient, can support the optical cage and enhance the structural strength of the optical cage, can closely fit with the optical cage, and prevent dust from entering the connector accommodation recess U.

Based on the same concept, an embodiment of this application further provides a communication device. The communication device may be a network switch, including a connector, an optical cage, and the port dust plug provided by the above embodiments, where the optical cage has an optical module slot, the port dust plug is inserted into the optical module slot, a sidewall of the optical cage covers an opening of the connector accommodation recess U to enclose a sealed space, and the connector is located within the sealed space.

When the port dust plug is inserted into the slot of the optical cage, the connector is located within the connector accommodation recess U, and the optical cage, the connector, and the port dust plug enclose a sealed space, with the connector isolated within the sealed space, allowing the connector to be not prone to interference from external dust, and achieving a favorable dustproof effect for the connector.

Apparently, persons skilled in the art can make various modifications and variations to this application without departing from the spirit and scope of this application. Thus, if these modifications and variations of this application fall within the scope of the claims of this application and their equivalent technologies, this application is also intended to include these modifications and variations.

What is claimed is:

1. A port dust plug, applied to an optical module slot of an optical cage, comprising:
a main body portion, wherein the main body portion is provided with an insertion end at an end of the port dust plug in an insertion and removal direction, and the insertion end is provided with a connector accommodation recess having an opening direction facing away from the main body portion.

2. The port dust plug according to claim 1, wherein the main body portion has a ventilation channel, and the main body portion further comprises:
one or more first ventilation openings provided at an end of the main body portion away from the insertion end, wherein the first ventilation openings are in communication with the ventilation channel.

3. The port dust plug according to claim 2, wherein the main body portion further comprises:
at least one third ventilation opening provided at the insertion end of the main body portion;
wherein the third ventilation opening is in communication with the ventilation channel.

4. The port dust plug according to claim 3, wherein the third ventilation opening is not in communication with the connector accommodation recess.

5. The port dust plug according to claim 4, wherein an arrangement direction of the third ventilation opening and the connector accommodation recess is a height direction of the port dust plug.

6. The port dust plug according to claim 3, wherein the main body portion has at least two longitudinal convex ribs arranged at intervals and extending along the insertion and removal direction; and
the at least two longitudinal convex ribs form a strip-shaped groove, and the ventilation channel is formed in the strip-shaped groove.

7. The port dust plug according to claim 6, wherein the strip-shaped groove is internally provided with at least two transverse convex ribs arranged at intervals along the insertion and removal direction, and the at least two transverse convex ribs are connected to the at least two longitudinal convex ribs.

8. The port dust plug according to claim 7, wherein upper surfaces of the at least two transverse convex ribs are lower than upper surfaces of the at least two longitudinal convex ribs.

9. The port dust plug according to claim 6, wherein the main body portion further comprises:
a second ventilation opening, wherein the second ventilation opening is arranged in the strip-shaped groove, and an orientation of the second ventilation opening is perpendicular to the insertion and removal direction and perpendicular to a width direction of the port dust plug.

10. The port dust plug according to claim 1, wherein a material of the main body portion is an elastic material.

11. The port dust plug according to claim 1, wherein the connector accommodation recess is a groove, and the groove extends in a width direction of the main body portion.

12. The port dust plug according to claim 11, wherein an end face of the insertion end is provided with two protruding ribs, and the two protruding ribs and a bottom of the connector accommodation recess form the groove.

13. The port dust plug according to claim 12, wherein the two protruding ribs are integrally formed with the main body portion.

14. The port dust plug according to claim 12, wherein two ends of the groove in an extension direction of the groove are through.

15. The port dust plug according to claim 12, wherein the two protruding ribs are parallel to each other.

16. The port dust plug according to claim 12, wherein the two protruding ribs intersect each other.

17. The port dust plug according to claim 12, wherein each of the two protruding ribs has a surface facing the other, the surface is provided with a flared slope, and a distance between the flared slopes of the two protruding ribs gradually increases in a direction facing away from the main body portion.

18. The port dust plug according to claim 1, wherein a bottom of the connector accommodation recess is an arc surface or a flat surface.

19. The port dust plug according to claim 1, wherein the main body portion is provided with a handheld end at an end away from the insertion end, the handheld end is provided with a handle, and the handle is provided with a skidproof stripe.

20. A communication device, comprising:
a connector;
an optical cage, wherein the optical cage has an optical module slot; and
the port dust plug according to claim 1, wherein the port dust plug is inserted into the optical module slot, the optical cage slot and the connector accommodation recess form a sealed space, and the connector is located within the sealed space.
